(19) United States
(12) Patent Application Publication
(10) Pub. No.: US 2015/0254326 A1
(43) Pub. Date: Sep. 10, 2015

(54) FILE BROWSING METHOD FOR AN ELECTRONIC DEVICE

(71) Applicants: QUANTA COMPUTER INC., Tao Yuan Shien (TW); STREAMING21 INTERNATIONAL INC., San Jose, CA (US)

(72) Inventors: Jung-Shen LEE, Hsinchu City (TW); Meng-Jou LIN, New Taipei City (TW)

(73) Assignees: QUANTA COMPUTER INC., Tao Yuan Shien (TW); STREAMING21 INTERNATIONAL INC., San Jose, CA (US)

(21) Appl. No.: 14/263,406

(22) Filed: Apr. 28, 2014

(30) Foreign Application Priority Data
Mar. 7, 2014 (TW) 103107815

(51) Int. Cl. G06F 17/30

(52) U.S. Cl. CPC G06F 17/30598; G06F 17/30424

(57) ABSTRACT

A file browsing method for an electronic device includes: display a grouping parameter selection region, a sorting parameter selection region, a scenario selection region and a result showing region on the electronic device; in response to a selection in a scenario of the scenario selection region, using at least a grouping parameter and a sorting parameter of the selected scenario by the electronic device; and based on the grouping parameter and the sorting parameter, grouping and sorting a plurality of files by the electronic device and displaying a result. When the electronic device generates or receives the files, the electronic device adding a plurality of meta-data to the files, wherein the meta-data are used to mark attributes to the files.

This application claims the benefit of Taiwan application Serial No. 103107815, filed Mar. 7, 2014, the subject matter of which is incorporated herein by reference.

### BACKGROUND OF THE INVENTION

1. Field of the Invention

The invention relates in general to a file browsing method for an electronic device, and more particularly to a file browsing method for an electronic device capable of sorting and grouping files and displaying the result according to meta-data of the files.

2. Description of the Related Art

When a user operates a personal computer (PC), a file browsing software (such as “file manager” application of the Windows operation system) of an operating system of the PC uses a conventional sorting method which sorts files according to such as file name, file size, creation date and modification date. File extension can be used to differentiate file types. In general, the “file manager” application categorizes files to folders. In order to find a desired file, the user has to remember the folder in which the file is possibly contained.

Electronic device has become more and more popular in people life. However, the user of an electronic device will experience inconvenience if file sorting of the electronic device is still based on folder grouping.

Therefore, a better file sorting method for an electronic device which groups and sorts files in an intuitive manner will greatly help the user find his/her desired file and information.

### SUMMARY OF THE INVENTION

The invention is directed to a file sorting method of an electronic device, for finding the file by using a plurality of meta-data added to the files.

The invention is directed to a sorting method for an electronic device, for grouping and sorting files in a pre-defined scenario or a user-defined scenario so that the user may be conveniently and quickly find the target file.

According to one embodiment of the present invention, a file browsing method for an electronic device is disclosed. A grouping parameter selection region, a sorting parameter selection region, a scenario selection region and a result showing region are displayed on an electronic device. In response to a selection on a scenario of the scenario selection region, at least a grouping parameter and at least a sorting parameter of the selected scenario are applied by the electronic device. A plurality of files are grouped and sorted according to the grouping parameter and the sorting parameter and a result is displayed on the electronic device. Meta-data are added to files by the electronic device when the electronic device generates or receives files, wherein the meta-data are used to mark attributes to the files.

The above and other contents of the invention will become better understood with regard to the following detailed description of the preferred but non-limiting embodiment (s). The following description is made with reference to the accompanying drawings.

### BRIEF DESCRIPTION OF THE DRAWINGS

FIG. 1 shows a schematic diagram of a result of file grouping and sorting by a file browser according to an embodiment of the disclosure.

FIG. 2 shows a schematic diagram of scenario setting by a file browser according to an embodiment of the disclosure.

FIG. 3 shows a schematic diagram of a “shopping” scenario of a file browser according to an embodiment of the disclosure.

### DETAILED DESCRIPTION OF THE INVENTION

Technical terms of the disclosure are based on general definition in the technical field of the disclosure. If the disclosure describes or explains one or some terms, definition of the terms is based on the description or explanation of the disclosure.

Each of the disclosed embodiments has one or more technical features. In possible implementation, one skilled person in the art would selectively implement part or all technical features of any embodiment of the disclosure or selectively combine part or all technical features of the embodiments of the disclosure.

The file browser of an embodiment of the disclosure groups and sorts files according to grouping and sorting parameters which may be pre-defined or defined by the user.

Refer to Table 1. Table 1 illustrates parameters used in the grouping and sorting of files according to an embodiment of the disclosure. However, the embodiment of the disclosure is not limited by the parameters disclosed below, and anyone who is skilled in the technology field of the disclosure may make changes or modifications on the parameters to fit actual needs. That is, the parameters applicable to the embodiment of the disclosure may be expanded according to actual needs and are still within the spirit of the disclosure.

In the embodiment of the disclosure, parameters are information added to the files, to mark special attributes to the files. When an electronic device generates or receives the files, the electronic device may use the parameters as meta-data and further add the parameters to the files. In the embodiment of the disclosure, the files are differentiated by the meta-data for file grouping and sorting.

TABLE 1

| Category | Parameter | Value |
|---|---|---|
| Sorting | Creation Time | Time Stamp |
| | File Name | File Name |
| | File Size | File Size |
| | Distance | Distance |
| Grouping | File Type | Photo |
| | | Music |
| | | Video |
| | | Document |
| | | PDF |
| | | APK |
| | | Others |
| | Device | iPhone |
| | | iPod |
| | | iPad |
| | | Android Phone |
| | | Android Tablet |
| | | Windows Phone |
| | | PC |
| | | Others |
| | App | App Name |
| | Service | Service Name |
| | Owner | Owner Name |
| | Location | Area Name |

As indicated Table 1, the “creation time” parameter represents the creation time of a file, the “file name” parameter represents the name of a file, the “file size” parameter represents the size of a file, and the “distance” parameter represents such as the distance between a current location of an electronic device and a photo shooting location. The file may be sorted according to the above parameters.

The “file type” parameter refers to the type of a file. When files are grouped according to the “file type” parameter, the user may select to group the files according to the file type such as photo, video, and so on. The “device type” parameter refers to the device which generates the files.

When files are grouped according to the “device type” parameter, the user may select the device type, which generates (or stores) the files, as a grouping parameter. The user may still remember which files are generated by his/her mobile phone, and which files are generated by (or stored in) his/her tablet PC. In the embodiment of the disclosure, the files are grouped according to the “device type” parameter, so that the user experience may be further enhanced.

The “App” parameter represents the application which generates the file. When files are grouped according to the “App” parameter, the files generated by different applications will be grouped as different groups. That is, the files generated by the Application A will be grouped together as one group, and the files generated by the Application B will be grouped together as another group.

The “service” parameter represents the service provider which generates or provides the file. When files are grouped according to the “service” parameter, the files generated by different service providers will be grouped as different groups. For example, the files generated by the service provider A (such as Facebook) will be grouped together as one group, and the files generated by the service provider B will be grouped together as another group.

The “owner” parameter represents the owner of the file. When files are grouped according to the “owner” parameter, the files owned by different owners will be grouped as different groups. For example, the files owned or shared by the owner A will be grouped as one group, and the files owned or shared by the owner B will be grouped as another group.

The “location” parameter represents the located at which the file is generated. The location parameter is such as country name, city name, or latitude and longitude coordinates. When files are grouped according to the “location” parameter, the files generated at different locations will be grouped as different groups. For example, the files generated at the location A will be grouped together as one group, and the files generated at the location B will be grouped together as another group.

The above parameters may be generated by an electronic device applying the embodiment of the disclosure; or the above parameters, generated by an electronic device not applying the embodiment of the disclosure, may be used by the electronic device applying the embodiment of the disclosure. That is, it is not necessary that the parameters must be generated by the Apps applying the embodiment of the disclosure.

The data structure of the said parameters is described below. The “owner” parameter, the “device type” parameter, the “App” parameter, and the “creation time” parameter may be represented by text. The “location” parameter includes latitude and longitude coordinates, and may be represented by real numbers. The “file type” parameter may be represented by integers. For example, the file type of a photo file may be set as 1, and the file type of a video file may be set as 2, and so on.

Besides, if the embodiment of the disclosure adds an additional parameter, such as a “key word” parameter, to a file, the user may search files according to the “key word” parameter, and the user will have more interest and convenience in file search.

To make the user's operation of the electronic device more convenient, use scenarios are introduced in the embodiment of the disclosure. The use scenario is a combination of sorting parameters and grouping parameters. The use scenario may be predetermined by developer with respect to a target scenario, or may be defined by the user. The use scenario includes pre-defined scenarios and user-defined scenarios. If the user selects pre-defined scenarios, then the user does not need to manually select the sorting and grouping parameters. For the convenience of the user's operation, the file browser of the embodiment of the disclosure provides several pre-defined scenarios in advance.

The first one of the pre-defined scenario will be treated as a system default scenario. Also, the system default scenario may be changed or set according to the user usage habits so that the system default scenario may be closer to the real situations.

Although the embodiment of the disclosure provides several pre-defined scenarios, the embodiment of the disclosure also provides a “user-defined” scenario to increase the flexibility of the user's operation. That is, the user may select his/her favorite grouping and sorting parameters. The parameter selected by the user in a “user-defined” scenario may be applied to the file browser using the embodiment of the disclosure. Moreover, the parameter selected or changed by the user in the “user-defined” scenario may be reserved. If the parameter selected or changed by the user in the “user-defined” scenario is not reserved, the selected parameter will become invalid once the file browser is closed.

According to the embodiment of the disclosure, if the user selects an “automatic mode”, then, a scenario is automatically selected from the pre-defined scenarios according to the user's current location (or current time); and files will be grouped and sorted according to the selected scenario. Thus, the user may conveniently and quickly find the target file. For example, in the automatic mode, if the electronic device detects that the user is currently in a sports venue, then the electronic device may automatically select the grouping and sorting parameters that are most suitable to the sports scenario. For example, since many people are used to playing sports and listening to music at the same time, it is very likely that their most preferred file type would be music file. Therefore, the scenario automatically selected by the file browser of the embodiment of the disclosure will group/sort files according to the “music file” parameter.

A number of scenarios and associated parameters are disclosed below for descriptions purpose, not for limiting the embodiment of the disclosure. Refer to Table 2.

TABLE 2

| | Grouping parameter (by order) | | | | |
|---|---|---|---|---|---|
| Scenario | 1 | 2 | 3 | 4 | 5 |
| Sports | File type | File type | Location | | |
| | (music) | (video) | | | |
| Shopping | File type | Location | | | |
| | (photo) | | | | |
| Work | File type | Owner | Service | | |
| | (document) | | | | |
| Leisure | File type | File type | Location | Device | |
| | (music) | (photo) | | type | |
| Study | File type | File type | Owner | Service | |
| | (video) | (document) | | | |
| Social | File type | File type | File type | Owner | Service |
| | (photo) | (video) | (music) | | |

Sorting parameter (by order)

| Scenario | 1 | 2 | 3 |
|---|---|---|---|
| Sports | File name | | |
| Shopping | File name | Creation time | Distance |
| Work | Creation time | File name | File size |
| Leisure | File name | Creation time | |
| Study | Creation time | File name | |
| Social | Creation time | File name | Distance |

Let the “sports” scenario of Table 2 be taken for example. It is very common that people like to listen to music or watch films when playing sports. Therefore, in file grouping, the file type (music) parameter is used as a most preferred parameter, and the remaining files other than the music files are grouped according to the file type (video) parameter. The music files and video files are divided into a music file group and a video file group. Then, the music file group and the video file group are further sub-grouped according to the location parameter. For each sub-group, the files are sorted according to the file name, and the result of file grouping and sorting is displayed. By doing so, when playing sports, the user may quickly find his/her desired music/video file.

Let the “shopping” scenario of Table 2 be taken for example. When people are shopping, they may like to refer to the photos posted on webpages or shared by others. According to the embodiment of the disclosure, if the user selects the “shopping” scenario, the photo files are firstly grouped as one group and are further sub-grouped according to the “location” parameter. The photo files in each sub-group are further sorted according to the “creation time” parameter. Thus, the user may quickly find photos that are helpful to his/her shopping. That is, after the user selected the “shopping” scenario, the files are grouped according to file type, and then photo files in the same group are further sub-grouped according to the “location” parameter. Then, the photo files in each sub-group are further sorted according to the “file name” parameter, the “creation time” parameter and the “distance” parameter, and the results of grouping and sorting are displayed.

The sorting and grouping principles used in the embodiment of the disclosure are disclosed below. In practical application, the embodiment of the disclosure will perform grouping first and then sorting.

During grouping, files are grouped according to a first grouping parameter of the use scenario (for example, files are grouped as group A and group B). If the user scenario further includes a second grouping parameter, then the result of file grouping may be grouped into sub-groups again according to the second grouping parameter. That is, the group A is grouped again according to the second grouping parameter, and so is the group B. Or, the files that are not grouped in the first run of file grouping are grouped according to the second grouping parameter. The above grouping process is repeated until all grouping parameters of the user scenario have all been used in the grouping process.

During sorting, when each of the sub-groups is sorted, sorting on the sub-groups is not in a cross-group sorting. For example, all files are grouped as sub-groups A-D, and then the sub-groups A-D are sorted. Likewise, during the sorting process, the files are sorted according to one or more sorting parameters. In an embodiment of the disclosure, if the files are sequentially sorted according to the “file name” parameter and the “creation time” parameter (that is, the scenario includes a “file name” parameter and a “creation time” parameter), then the sub-group A is sorted according to the “file name” parameter first, and then sorted according to the “creation time” parameter.

Furthermore, if the electronic device is connected to a mobile network, then the electronic device obtains an information service provided by location based service (LBS). In general, LBS provides current location information and time information to the electronic device. Through the LBS information and other information related to the electronic device, the electronic device of the embodiment of the disclosure generates useful information in selecting an optimum scenario in the automatic mode.

If the user knows that there are friends in the vicinity of the current location based on the information from the LBS information, then the electronic device will automatically select the “file sharing” scenario so that the user may share files with his/her friends.

The user device may receive e-coupons or e-flyers of the shops nearby from the LBS information. If the user decides to use these coupons and flyers, then the electronic device will automatically select the “shopping” scenario, so that the user may conveniently and quickly select the files needed for the shopping purpose.

If the electronic device detects that there is a restaurant or a social activity (or a social event) in the vicinity of the current location (such as a concert or a convert hall) based on the LBS information, then the electronic device will automatically select the “file sharing” scenario, so that the user may conveniently share the photos to his/her friends.

If the electronic device determines that there is traffic jam in the vicinity of the current location based on the LBS information, then the electronic device will automatically select the “music” scenario, so that the user can conveniently find music file for pleasure.

If the electronic device determines that a friend is playing games in the vicinity of the current location (for example, at a game center) based on the LBS information, then the electronic device will automatically select the “App” scenario, so that the user may conveniently find an App or even may play games with his/her friend via a wireless network. In the “App” scenario, the electronic device may display a link path (which is presented in for example, an icon), for example connection to such as a game center, you-tube, or App download.

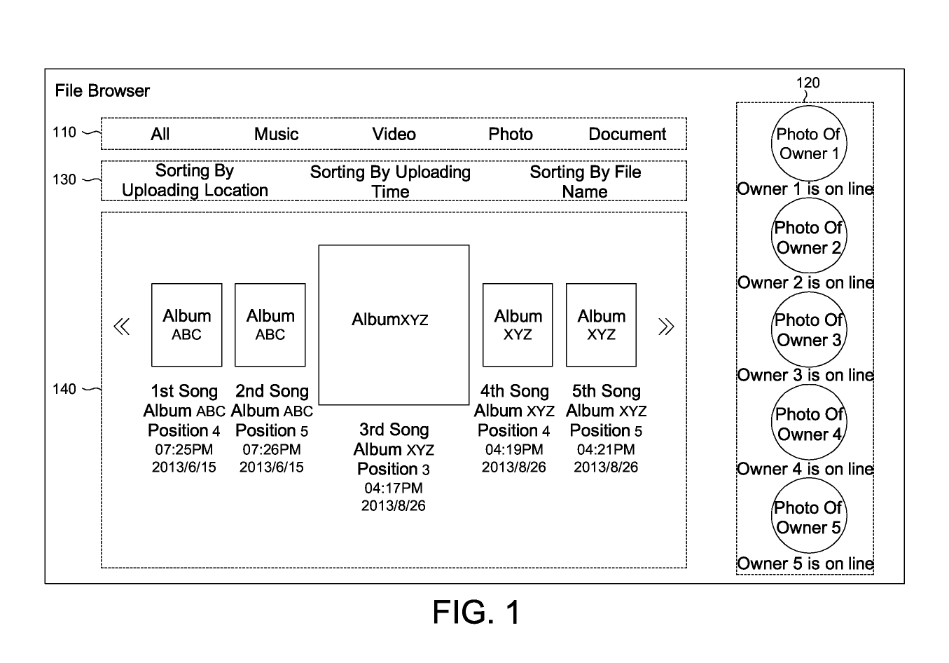

Referring to FIG. 1, a result of file grouping and sorting obtained by a file browser according to an embodiment of the disclosure is shown. When the file browser applying the embodiment of the disclosure is activated, the user may select a scenario. The file browser applying the embodiment of the disclosure displays grouping parameter selection regions 110 and 120, a sorting parameter selection region 130 and a result showing region 140 on the electronic device. The parameters of the grouping parameter selection region 110 include: “all”, “music”, “video”, “photo” and “document”. Suppose the user clicks a grouping option of the grouping parameter selection region 110 and selects “music file” type (that is, the grouping parameters include the “file type” parameter), then all files are grouped according to the “file type” parameter. Then, the user clicks the grouping parameter selection region 120 and selects “owner” (that is, the grouping parameter includes the “owner” parameter). Thus, the music files of the music file group will be sub-grouped according to the “owner” parameter. Suppose the user selects “owner 3”, then all music files owned by the owner 3 will be grouped as a sub-group. Then, the user may click the sorting parameter selection region 130 (including: “sorting by uploading location” parameter, “sorting by uploading time” parameter and “sorting by file name” parameter). Suppose the user clicks “sorting by uploading time”, then the music files owned by the owner 3 will be sorted according to the “uploading time” parameter, and the final result of file grouping and sorting will be as indicated in the result showing region 140.

Refer to FIG. 1. The file browser of the electronic device according to the embodiment of the disclosure may display parameters associated with a selected scenario for the user to select grouping and sorting parameters (or, if the user selects the “automatic mode”, the file browser may automatically apply the grouping and sorting parameters), then the file browser may group and sort the files according to the grouping and sorting parameters. Thus, the user may select a desired file on the electronic device. The user does not sort and group the files by “folders” as what the file manager of a PC would do. The embodiment of the disclosure provides great convenience to the user in operating the electronic device.

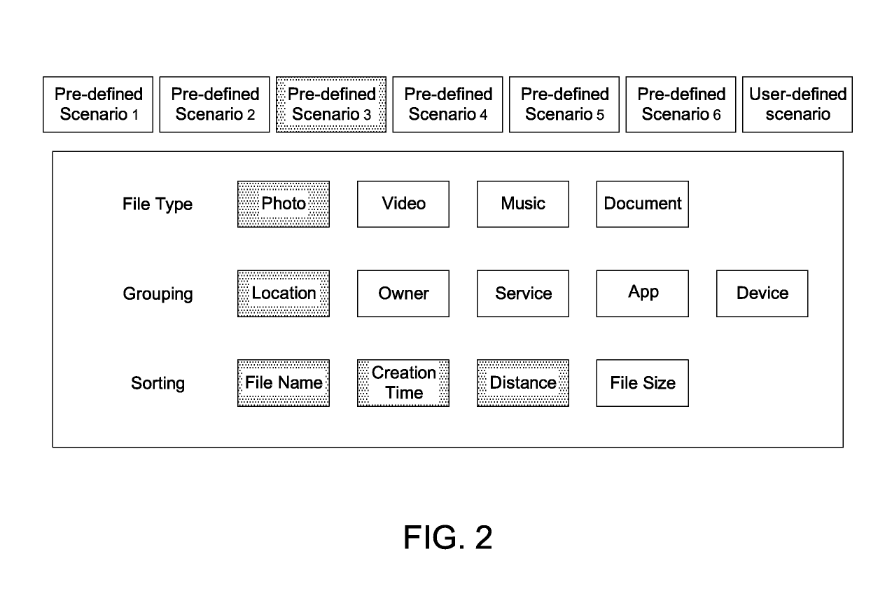

Referring to FIG. 2, a schematic diagram of scenario setting performed by a file browser according to an embodiment of the disclosure is shown. Suppose the user currently selects a pre-defined scenario 3, but desires to modify the grouping and sorting parameters applied to the pre-defined scenario 3 to fit his/her needs. Then, after the user selected a scenario setting page, options of scenario setting will be displayed on the screen of the electronic device and the user may change or set the parameters of the currently selected scenario.

On the scenario setting page, the electronic device may display the parameters applied in the scenario. For example, if the user desires to expand the “file type” parameter, then the user may click “video”, and the file browser will apply the “video” parameter to the scenario. Also, the user may change the sequence of parameters by way of dragging. Let the sorting parameters be taken for example. The current sequence of sorting parameters is: “file”, “creation time” and “distance”. The user may drag the “distance” parameter to be ahead of the “creation time” parameter, and the sequence of sorting parameters will change as: “file”, “distance” and “creation time” (the display sequence of parameters will change accordingly). Moreover, the user may invalidate a currently applied parameter (which is highlighted). For example, the user may click the “file name” parameter to make it become valid/invalid, and click the “file name” parameter again to make it become invalid/valid. Besides, the user may double click a currently unselected parameter, and the parameter will be automatically inserted to the scenario.

The parameter change to the pre-defined scenario by the user may remain valid during the operation of the file browser. For example, the file browser may reserve the change made to the pre-defined scenario 3. Besides, the file browser applying the embodiment of the disclosure may permanently update a system default scenario (that is, pre-defined scenario 1) according to the usage habit so that the system default scenario is closer to actual situations of use. Furthermore, the update to the system default scenario does not become invalid even when the file browser is closed.

Likewise, if the user selects the “user-defined” scenario, then the file browser may reserve the change made to the “user-defined” scenario by the user. When the file browser is activated again, the “user-defined” scenario is exactly the same as the previously changed “user-defined” scenario.

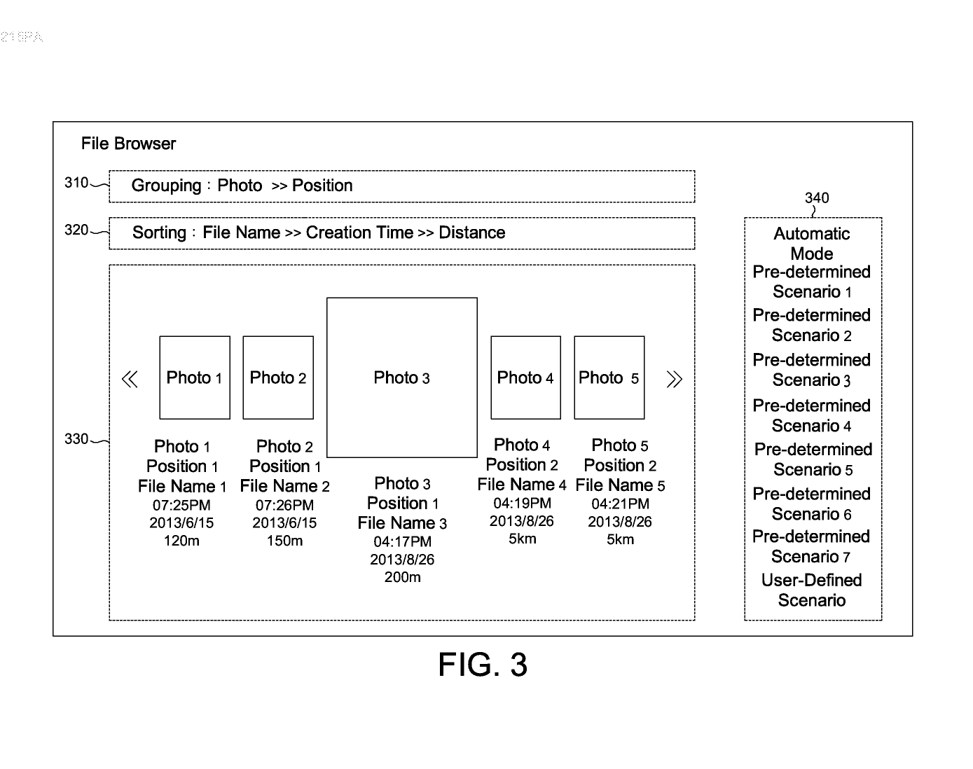

Referring to FIG. 3, a schematic diagram of a file browser in a “shopping” scenario according to an embodiment of the disclosure is shown. Like FIG. 1, the file browser may display a grouping parameter selection region 310, a sorting parameter selection region 320, a result showing region 330 and a scenario selection region 340. The grouping parameter selection region 310, the sorting parameter selection region 320, the result showing region 330 are similar to the grouping parameter selection regions 110 and 120, the sorting parameter selection region 130 and the result showing region 140 of FIG. 1, and the details are not repeated here. The user may click the scenario selection region 340 to select one scenario from the several scenarios. Also, the user may select another scenario at any time. In response to selection and change to the scenario, the file browser may group and sort the files according to the parameters of the selected scenario. Normally, when the file browser is activated, the user clicks a scenario on the scenario selection region 340 first, and the file browser will accordingly group and sort the files according to the parameters of the selected scenario.

If the user had selected a pre-defined scenario but selected another pre-defined scenario afterwards, then the file browser applying the embodiment of the disclosure may re-group and re-sort all files according to the latter-selected scenario and display the result of re-grouping and re-sorting.

If the user selects the “user-defined” scenario, then the file browser using the embodiment of the disclosure will check whether the “user-defined” scenario has been set by the user (that is, whether the “user-defined” scenario is still blank). If the “user-defined” scenario has not been set by the user (that is, the “user-defined” scenario is still blank; in other words, the “user-defined” scenario does not include any grouping or sorting parameters), then the system will reject the user's current selection, and will remind the user of setting the “user-defined” scenario first. If the “user-defined” scenario has been set by the user (that is, the “user-defined” scenario already includes at least a grouping/sorting parameter), then the file browser applying the embodiment of the disclosure will group and sort files according to the grouping and sorting parameters of the “user-defined” scenario and display a result of file grouping and sorting accordingly.

Besides, in the “user-defined” scenario, the user may select any of the grouping and sorting parameters, the file browser may apply the selected parameter, and the parameter selected/changed by the user will be reserved.

According to the embodiment of the disclosure, the grouping and sorting of files are based on the user's experience instead of using folders as what the file manager of a PC would do. The meta-data meaningful to the user are added to the files, and the file browser applying the embodiment of the disclosure groups and sorts according to the added meta-data. The result of file grouping and sorting obtained in this way is very user friendly.

Besides, by setting the scenario of use, the user may quickly and conveniently find his/her desired files, and may have more fun in using the electronic device.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A file browsing method for an electronic device, comprising:
displaying a grouping parameter selection region, a sorting parameter selection region, a scenario selection region and a result showing region on the electronic device;
in response to selection on a scenario of the scenario selection region, applying at least a grouping parameter and at least a sorting parameter of the selected scenario by the electronic device; and
grouping and sorting a plurality of files and displaying a result of file grouping and sorting by the electronic device according to the grouping parameter and the sorting parameter,
wherein the electronic device adds a plurality of meta-data to the files when the electronic device generates or receives the files, the meta-data used to mark attributes to the files.

2. The file browsing method for an electronic device according to claim 1, wherein,
the scenario selection region comprises a plurality of pre-defined scenarios, a user-defined scenario and an automatic mode.

3. The file browsing method for an electronic device according to claim 2, wherein,
in response to selection on the automatic mode, the electronic device selects one of the pre-defined scenarios according to a current situation.

4. The file browsing method for an electronic device according to claim 1, further comprising:
displaying the grouping parameter selection region, the sorting parameter selection region, the scenario selection region and the result showing region on a file browser by the electronic device.

5. The file browsing method for an electronic device according to claim 4, further comprising:
displaying a scenario setting page on the file browser by the electronic device;
displaying the grouping parameter and the sorting parameter of the selected scenario on the scenario setting page; and
in response to an operation event, changing the grouping parameter and/or the sorting parameter of the selected scenario.

6. The file browsing method for an electronic device according to claim 5, further comprising:
reserving change to the grouping parameter and/or the sorting parameter of the selected scenario.

7. The file browsing method for an electronic device according to claim 4, further comprising:
in response to selection on the user-defined scenario,
if the user-defined scenario is not blank, then the electronic device groups and sorts the files according to at least a parameter of the selected user-defined scenario; and
if the user-defined scenario is blank, then the electronic device rejects selection on the user-defined scenario.

8. The file browsing method for an electronic device according to claim 7, further comprising:
reserving change to the user-defined scenario by the electronic device.

9. The file browsing method for an electronic device according to claim 4, further comprising:
based on a user usage habit, updating a system pre-defined scenario of a plurality of pre-defined scenarios by the electronic device, wherein updating to the system pre-defined scenario is still valid even when the file browser is closed.

10. The file browsing method for an electronic device according to claim 1, further comprising:
obtaining a plurality of meta-data of the files by the electronic device; and
grouping and sorting the files by the electronic device according to the grouping parameter, the sorting parameter and the meta-data.
